(19) United States
(12) Patent Application Publication
(10) Pub. No.: US 2019/0367402 A1
(43) Pub. Date: Dec. 5, 2019

(54) METHODS TO COMPENSATE FOR WARP IN GLASS ARTICLES

(71) Applicant: CORNING INCORPORATED, CORNING, NY (US)

(72) Inventors: Rohit Rai, Painted Post, NY (US); John Richard Ridge, Hammondsport, NY (US)

(21) Appl. No.: 16/425,382

(22) Filed: May 29, 2019

Related U.S. Application Data
(60) Provisional application No. 62/677,932, filed on May 30, 2018.

(51) Int. Cl. C03B 23/025; C03C 21/00; C03C 19/00

(52) U.S. Cl. CPC C03B 23/0252; C03C 19/00; C03C 21/002

(57) ABSTRACT

A method for compensating for warp in a glass article including placing the glass article on a fixture, heating the glass article to a first temperature in a viscoelastic range, cooling the glass article on the fixture to a second temperature, and then removing the glass article from the fixture and cooling the glass article to room temperature. The fixture may include a recess such that when the glass article is heated to the first temperature, the glass article sags into the recess. The fixture may be a flat plate when the glass article is heated to the first temperature, a temperature gradient is formed within the glass article. A method for compensating for warp includes physically removing portions of the glass article that are determined to warp when chemically strengthened.

### CROSS-REFERENCE TO RELATED APPLICATIONS

This application claims the benefit of priority under 35 U.S.C. § 119 of U.S. Provisional Application Ser. No. 62/677,932 filed on May 30, 2018, the content of which is relied upon and incorporated herein by reference in its entirety.

### BACKGROUND

The present specification generally relates to compensating for warp in glass articles and, more specifically, to compensating for warp in 2.5D glass articles that are to be chemically strengthened.

Many electronic display devices have chemically strengthened cover glass to improve scratch resistance and reduce the probability of failure in a drop event. A side-effect of the chemical strengthening step is glass dilatation, which in case of asymmetric shapes, can cause unbalanced bending moments and significant warp of the glass article. 3D and 2.5D cover glass designs have such inherent asymmetry in the direction of device thickness that can lead to significant warp.

The problem of warp in 3D articles has been known for some time, and is typically compensated for by adding a surface correction—reverse of ion exchange warp—to the mold used for forming the 3D shape. Glass is then formed on this compensated mold by the application of a forming pressure at forming viscosities. The profile correction is determined either empirically or by using a finite element analysis model for the warp. However, this method cannot be conducted on glasses that are not formed in a mold.

Accordingly, a need exists for methods to compensate for warp in glass articles that are not formed in a mold.

### SUMMARY

According to one embodiment, a method for compensating for warp in a glass article comprises placing a first surface of the glass article on a first surface of a fixture, wherein the glass article comprises the first surface, a second surface opposite to the first surface, and a plurality of edge surfaces at a periphery of the glass article that span between the first surface and the second surface, and the fixture comprises the first surface having a recess configured so that when the first surface of the glass article is placed on the first surface of the fixture only a portion of the first surface of the glass article contacts the first surface of the fixture. Then, the glass article is heated to a first temperature in a viscoelastic range such that the glass article sags into the recess in the first surface of the fixture. The glass article is cooled on the fixture to a second temperature.

In another embodiment, a method for compensating for warp in a glass article comprises placing a first surface of the glass article on a first surface of a fixture, wherein the glass article comprises the first surface, a second surface opposite the first surface, and a plurality of edge surfaces at a periphery of the glass article that span between the first surface and the second surface, and the fixture comprises the first surface configured so that when the first surface of the glass article is placed on the first surface of the fixture, the first surface of the glass article is supported by the first surface of the fixture. The glass article is then heated to a first temperature in a viscoelastic range. The glass article is then cooled on the fixture to a second temperature such that a temperature gradient exists from the first surface of the glass article to the second surface of the glass article.

In another embodiment, a method for compensating for warp in a glass article comprises removing a portion from a surface of the glass article determined to provide compensation for warping caused by chemical strengthening; and ion exchanging the glass article by contacting the glass article with an ion exchange solution comprising a molten salt selected from molten potassium nitrate, molten sodium nitrite, and a mixture thereof at a temperature of greater than or equal to 360° C.

According to a first clause, a method for compensating for warp in a glass article comprises: placing a first surface of the glass article on a first surface of a fixture, wherein the glass article comprises the first surface, a second surface opposite to the first surface, and a plurality of edge surfaces at a periphery of the glass article that span between the first surface and the second surface, and the fixture comprises the first surface having a recess configured so that when the first surface of the glass article is placed on the first surface of the fixture only a portion of the first surface of the glass article contacts the first surface of the fixture; heating the glass article to a first temperature in a viscoelastic range such that the glass article sags into the recess in the first surface of the fixture; and cooling the glass article on the fixture to a second temperature.

A second clause comprises the method according to the first clause, wherein the glass article is a 2.5D glass article and at least one of the plurality of edge surfaces is a beveled edge surface.

A third clause comprises the method according to the second clause, wherein the beveled edge surface is configured such that when the first surface of the glass article is placed on the first surface of the fixture, the beveled edge surface is facing the first surface of the fixture.

A fourth clause comprises the method according to any one of the first to third clauses, wherein the recess is a through-hole in the fixture.

A fifth clause comprises the method according to any one of the first to third clauses, wherein the recess is a concave portion in the first surface of the fixture.

A sixth clause comprises the method according to any one of the first to fifth clauses, wherein the recess has an average depth of at least 2 mm.

A seventh clause comprises the method according to any one of the first to sixth clauses, wherein heating the glass article to the first temperature comprises heating the glass article to a temperature where a viscosity of the glass article is from greater than or equal to 10⁸ poise to less than or equal to 10¹² poise.

An eighth clause comprises the method according to any one of the first to seventh clauses, wherein heating the glass article to the first temperature comprises heating the glass article to a temperature where the viscosity of the glass article is from greater than or equal to 10⁹ poise to less than or equal to 10¹¹ poise.

A ninth clause comprises the method according to any one of the first to eighth clauses, wherein cooling the glass article to the second temperature comprises cooling the glass article to temperature where a viscosity of the glass article is greater than or equal to 10¹¹ poise.

A tenth clause comprises the method according to any one of the first to ninth clauses, wherein the method further comprises, after cooling the glass article to room temperature, ion exchanging the glass article by contacting the glass article with an ion exchange solution comprising a molten salt selected from molten potassium nitrate, molten sodium nitrite, and a mixture thereof at a temperature of greater than or equal to 360° C.

An eleventh clause comprises the method according to the tenth clause, wherein the warp/diagonal of the glass article after the glass article has been ion exchanged is less than or equal to 6.0×10⁻⁶/mm.

According to a twelfth clause, a method for compensating for warp in a glass article comprises: placing a first surface of the glass article on a first surface of a fixture, wherein the glass article comprises the first surface, a second surface opposite to the first surface, and a plurality of edge surfaces at a periphery of the glass article that span between the first surface and the second surface, and the fixture comprises the first surface configured so that when the first surface of the glass article is placed on the first surface of the fixture, the first surface of the glass article is supported by the first surface of the fixture; heating the glass article to a first temperature in a viscoelastic range; and cooling the glass article on the fixture to a second temperature such that a temperature gradient exists from the first surface of the glass article to the second surface of the glass article.

A thirteenth clause comprises the method according to the twelfth clause, wherein the glass article is a 2.5D glass article and at least one of the plurality of edge surfaces is a beveled edge surface.

A fourteenth clause comprises the method according to the thirteenth clause, wherein the beveled edge surface is configured such that when the first surface of the glass article is placed on the first surface of the fixture, the beveled edge surface is facing the first surface of the fixture.

A fifteenth clause comprises the method according to any one of the twelfth to fourteenth clauses, wherein heating the glass article to the first temperature comprises heating the glass article to a temperature where the viscosity of the glass article is from greater than or equal to 10⁹ poise to less than or equal to 10¹⁴ poise.

A sixteenth clause comprises the method according to any one of the twelfth to fifteenth clauses, wherein heating the glass article to the first temperature comprises heating the glass article to a temperature where the viscosity of the glass article is from greater than or equal to 10¹⁰ poise to less than or equal to 10¹³ poise.

A seventeenth clause comprises the method according to the twelfth to fifteenth clauses, wherein cooling the glass article on the fixture to a second temperature comprises cooling the glass article to temperature where a viscosity of the glass article is greater than or equal to 10¹⁴ poise.

An eighteenth clause comprises the method according to any one of the twelfth to seventeenth clauses, wherein the method further comprises, after cooling the glass article to room temperature, ion exchanging the glass article by contacting the glass article with an ion exchange solution comprising a molten salt selected from molten potassium nitrate, molten sodium nitrite, and a mixture thereof at a temperature of greater than or equal to 360° C.

A nineteenth clause comprises the method according to the eighteenth clause, wherein the warp/diagonal² of the glass article after the glass article has been ion exchanged is less than or equal to 6.0×10⁻⁶/mm.

According to a twentieth clause, a method for compensating for warp in a glass article comprises: removing a portion from a surface of the glass article determined to provide compensation for warping caused by chemical strengthening; and ion exchanging the glass article by contacting the glass article with an ion exchange solution comprising a molten salt selected from molten potassium nitrate, molten sodium nitrite, and a mixture thereof at a temperature of greater than or equal to 360° C.

A twenty first clause comprises the method of the twentieth clause, wherein the removing is done by CNC machining.

A twenty second clause comprises the method according to any one of the twentieth and twenty first clauses, wherein a thickness of the portion removed from the surface of the glass article is from greater than or equal to 50 μm to less than or equal to 200 μm.

A twenty third clause comprises the method of any one of the twentieth to twenty second clauses, wherein the warp/diagonal² of the glass article after the glass article has been ion exchanged is less than or equal to 6.0×10⁻⁶/mm.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A is a schematic of a side view of a glass article and fixture according to one or more embodiments disclosed and described herein;

FIG. 1B is a schematic of a side view of a glass article and fixture having a concave recess according to one or more embodiments disclosed and described herein;

FIG. 1C is a schematic of a cross-section view of a glass article and fixture having a through-hole according to one or more embodiments disclosed and described herein;

FIG. 2 is a schematic of a top view of a fixture according to one or more embodiments disclosed and described herein;

FIG. 3 is a schematic of a side view of a glass article and fixture without a recess according to one or more embodiments disclosed and described herein;

FIG. 4 is a schematic of a top view of a glass article according to one or more embodiments disclosed and described herein;

FIG. 5 graphically depicts the temperature within a furnace while performing a method according to one or more embodiments disclosed and described herein;

FIG. 6 graphically depicts the temperature profile of a fixture with a recess while performing a method according to one or more embodiments disclosed and described herein;

FIG. 7 graphically depicts the temperature profile of a fixture without a recess while performing a method according to one or more embodiments disclosed and described herein;

FIG. 8 graphically depicts the pre-ion exchange warp of glass articles according to one or more embodiments disclosed and described herein; and

FIG. 9 graphically depicts the post-ion exchange warp of glass articles according to one or more embodiments disclosed and described herein.

### DETAILED DESCRIPTION

Reference will now be made in detail to embodiments of methods for compensating for warp in glass articles caused by chemical strengthening, such as, for example, ion exchange strengthening, where the glass article is not formed with a mold. Whenever possible, the same reference numerals will be used throughout the drawings to refer to the same or like parts.

For the conditions of interest, warp and dilatation increase with increase in ion-exchange time, or more generally to the amount of larger ions, such as, for example, sodium ions or potassium ions, introduced in the glass during ion-exchange strengthening.

As a forming mold is not used for making 2D and 2.5D glass, ion exchange warp compensation cannot be imparted to the 2.5D glass before the ion exchange process using a mold as is done in the case of 3D articles. Furthermore, using a mold surface to impart ion exchange warp compensation has some demerits. First, the glass-to-mold contact at high temperatures and with simultaneous application of pressure can cause defects in the glass. Second, the method requires high precision surface machining which adds to the cost of the process. Embodiments disclosed and described herein address these, and other, issues that are presented when attempting to compensate for warp caused by chemically strengthening glass articles, such as, for example, by ion-exchange strengthening.

In one embodiment, a method for compensating for warp in a glass article comprises placing a first surface of the glass article on a first surface of a fixture, wherein the glass article comprises the first surface, a second surface opposite to the first surface, and a plurality of edge surfaces at a periphery of the glass article that span between the first surface and the second surface, and the fixture comprises the first surface having a recess configured so that when the first surface of the glass article is placed on the first surface of the fixture only a portion of the first surface of the glass article contacts the first surface of the fixture. Then, the glass article is heated to a first temperature in a viscoelastic range such that the glass article sags into the recess in the first surface of the fixture. The glass article is cooled on the fixture to a second temperature, and is then removed from the fixture and cooled to room temperature.

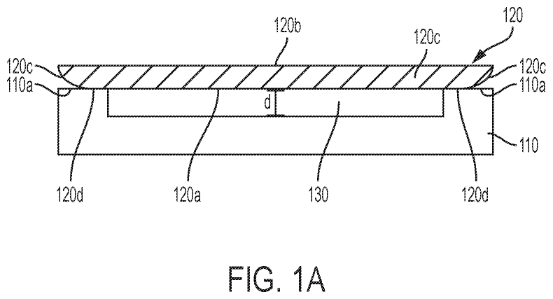

With reference now to FIGS. 1A-1C, a glass article 120 is placed on a fixture 110. The glass article 120 comprises a first surface 120a, a second surface 120b, which is opposite to the first surface 120a, and a plurality of edge surfaces 120c at a periphery of the glass article 120 and spanning between the first surface 120a and the second surface 120b. As shown in the embodiment depicted in FIGS. 1A-1C, the first surface 120a of the glass article 120 is placed on a first surface 110a of the fixture 110. The fixture 110 comprises a first surface 110a having a recess 130 configured so that when the first surface 120a of the glass article 120 is placed on the first surface 110a of the fixture 110 only a portion 120d of the first surface 120a of the glass article 120 contacts the first surface 110a of the fixture 110.

The shape of the glass article 120 is not particularly limited. In some embodiments, the glass article may be substantially rectangular in shape, which—as used herein—means that the glass article 120 has a rectangular shape with a two long sides of approximately the same length and two short sides of approximately the same length, but the corners where a long side meets a short side may be rounded or otherwise softened so that they do not meet at a 90° angle. In some embodiments, the one or more of the edge surfaces 120c of the glass article 120 may be beveled such that the one or more beveled edge surfaces 120c of the glass article 120 are not perpendicular to one or more of the first surface 120a and the second surface 120b of the glass article 120. As used herein, a “beveled edge surface” may have any shape such that it is not perpendicular to one or more of the first surface 120a and the second surface 120b of the glass article 120, thus a “beveled edge surface” includes a chamfered edge surface. Glass articles 120 comprising one or more beveled edge surfaces are commonly referred to as 2.5D glass articles. As an example, the glass articles 120 in the embodiments depicted in FIGS. 1A-1C comprise beveled edge surfaces on the two short sides of the glass article 120. In embodiments where the glass article 120 comprises one or more beveled edge surfaces, the one or more beveled edge surface will slope from the longer second surface 120b to the shorter first surface 120a. As used herein, this is a configuration where the beveled edge surface “faces” the first surface 120a of the glass article 120. Therefore, in some embodiments the one or more beveled edge surface slopes from the longer second surface 120b of the glass article 120 to the shorter first surface 120a of the glass article 120, and the shorter first surface 120a of the glass article 120 is placed on the first surface 110a of the fixture 110 (as depicted in FIGS. 1A-1C). This placement of the glass article 120 is referred to herein as the one or more beveled edge surfaces facing the first surface 110a of the fixture 110.

In embodiments, the glass article has a thickness from greater than or equal to 0.5 mm to less than or equal to 10.0 mm, such as from greater than or equal to 1.0 mm to less than or equal to 9.0 mm, from greater than or equal to 2.0 mm to less than or equal to 8.0 mm, from greater than or equal to 3.0 mm to less than or equal to 7.0 mm, or from greater than or equal to 4.0 mm to less than or equal to 6.0 mm. In some embodiments, the glass article has a thickness of less than 2.0 mm, such as less than or equal to 1.5 mm, less than or equal to 1.0 mm, or less than or equal to 0.5 mm.

The fixture 110, in some embodiments, comprises a recess 130 in the first surface 110a of the fixture 110. In some embodiments, the recess 130 is a concave portion of the fixture 110. As used herein, a concave portion is a portion of the first surface 110a of the fixture 110 that curves inward like the interior of a circle or sphere. In some embodiments, such as the embodiment depicted in FIG. 1A, the concave portion of the first surface 110a does not have uniform curvature and is asymmetrical. In some embodiments, such as the embodiment depicted in FIG. 1B, the concave portion of the first surface 110a has uniform curvature and is symmetrical.

In some embodiments, such as the embodiment depicted in FIG. 1C, the recess 130 in the first surface 110a of the fixture 110 is a through-hole. FIG. 1C is a cross-section view of the glass article 120 and the fixture 110, where the fixture 110 may have an annular shape or may be two substantially linear bars that support the glass article 120 at its short ends.

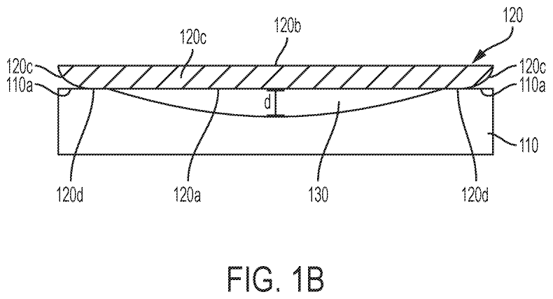

It should be understood that while FIGS. 1A-1C show the glass article 120 being supported along its short ends, in some embodiments, the glass article 120 may be supported along its long ends. In some embodiments, the fixture 110 may be configured to support the glass article along its long ends and its short ends. For example, FIG. 2 is a top view of a fixture 110 having a recess 130 that is configured in the first surface 110a of the fixture 110 to support a substantially rectangular-shaped glass article (not shown in FIG. 2) along its short end and its long end. It should be understood that in some embodiments, the recess 130 depicted in the fixture of FIG. 2 may be a concave portion of the first surface 110a of the fixture, and in some embodiments, the recess 130 depicted in FIG. 2 may be a through-hole in the fixture 110.

With reference again to FIGS. 1A-1C, whether the recess 130 in the fixture 110 is a concave portion of the first surface 110a of the fixture 110 or a through-hole in the fixture 110, the average depth d of the recess 130 as measured from a plane that contacts the first surface 110a of the fixture 110 to a surface of the recess 130 that is opposite from the plane that contacts the first surface 110a is, in some embodiments, greater than or equal to 2.0 mm, such as greater than or equal to 2.5 mm, greater than or equal to 3.0 mm, greater than or equal to 3.5 mm, or greater than or equal to 4.0 mm.

Once placed on the fixture 110, the glass article 120 is heated to a first temperature that is within the viscoelastic range such that the glass article 120 sags into the recess 130 in the first surface 110a of the fixture 110. This sagging of the glass article 120 into the recess 130 allows for compensation of warp that occurs during chemical strengthening of the glass article 120. The amount of sagging of the glass article 120 into the recess 130 is controlled by the temperature to which the glass article 120 is heated. In embodiments, the sagging may be limited by the dimensions of the recess. In some embodiments, the sagging may be enhanced by forming a vacuum that promotes the sagging of the glass article into the recess.

The glass composition of the glass article 120 is not limited, but it should be understood that different glass compositions will need to be heated to different temperatures to obtain the desired viscoelasticity. Therefore, in some embodiments, the glass article 120 is heated to a temperature where the viscosity of the glass is from greater than or equal to 10⁸ poise to less than or equal to 10¹² poise, such as from greater than or equal to 10⁸ poise to less than or equal to 10¹¹ poise, from greater than or equal to 10⁸ poise to less than or equal to 10¹⁰ poise, or from greater than or equal to 10⁸ poise to less than or equal to 10⁹ poise. In some embodiments, the glass article 120 is heated to a temperature where the viscosity of the glass is from greater than or equal to 10⁹ poise to less than or equal to 10¹² poise, from greater than or equal to 10¹⁰ poise to less than or equal to 10¹² poise, or from greater than or equal to 10¹¹ poise to less than or equal to 10¹² poise. In some embodiments, the glass article 120 is heated to a temperature where the viscosity of the glass is from greater than or equal to 10⁹ poise to less than or equal to 10¹¹ poise. The viscosity may be measured by conventional measuring techniques, such as parallel plate viscosity measurement technique.

Once the glass article 120 is heated to a temperature such that the glass article 120 sags into the recess 130 to the desired depth, the glass article 120 may be cooled to a second temperature that is below the first temperature described above. This cooling allows the glass article 120 to become more viscous so that it can safely be removed from the fixture 110. As discussed above, different glass compositions will need to be cooled to different temperatures to obtain the desired viscosity. In some embodiments, the glass article 120 is cooled to a second temperature such that the glass article 120 has a viscosity that is greater than or equal to 10¹¹ poise, such as greater than or equal to 10¹² poise, greater than or equal to 10¹³ poise, greater than or equal to 10¹⁴ poise, greater than or equal to 10¹⁵ poise, greater than or equal to 10¹⁶ poise, or greater than or equal to 10¹⁷ poise.

It should be understood that in embodiments, the glass article may be heated and cooled by any suitable method or mechanism. For example, in some embodiments, the fixture 110 and the glass article 120 may be placed in a furnace to heat the glass article 120, and after heating the glass article 120 may be allowed to cool without introducing any cooling gas into the furnace, or a gas may be introduced into the furnace to promote cooling of the glass article 120. In some embodiments, a door of the furnace may be opened to promote cooling of the glass article 120. In some embodiments, the glass article 120 may be heated by heating the fixture 110 and allowing conduction of the heat from the fixture 110 to the glass article 120.

Once the glass article 120 is cooled to the second temperature, the glass article 120 is removed from the fixture 110 and allowed to cool to room temperature. This can be done by removing the glass article 120 from the fixture 110 and allowing the glass article 120 to sit at ambient conditions for a period of time, or this can be done by removing the glass article 120 from the fixture 110 and actively cooling the glass article by any suitable method or mechanism.

As discussed above, embodiments disclosed herein may compensate for warp that occurs when the glass article 120 is chemically strengthened, such as, for example, by ion exchange strengthening. Ion exchange strengthening is, in some embodiments, conducted by contacting the glass article 120—after it has been cooled to room temperature—with an ion exchange solution comprising a molten salt selected from the group consisting of molten potassium nitrate (KNO₃), molten sodium nitrate (NaNO₃), molten silver nitrate (AgNO₃), and mixtures thereof. The ion exchange solution may, in some embodiments, be maintained at a temperature from greater than or equal to 360° C., such as greater than or equal to 380° C., greater than or equal to 400° C., greater than or equal to 420° C., greater than or equal to 440° C., or greater than or equal to 450° C. In embodiments, the maximum temperature of the ion exchange solution is less than or equal to 550° C. It should be understood that any ion exchange strengthening process may be used to chemically strengthen the glass article 120, and the type of ion exchange process that is used—including the type of ion exchange solution used—will depend upon the composition of the glass article 120.

After the ion exchange strengthening process, the warp/diagonal² of the glass article, according to some embodiments, is less than or equal to 6.0×10⁻⁶/mm, such as less than or equal to 5.5×10⁻⁶/mm, less than or equal to 4.5×10⁻⁶/mm, less than or equal to 4.0×10⁻⁶/mm, less than or equal to 3.5×10⁻⁶/mm, less than or equal to 3.0×10⁻⁶/mm, less than or equal to 2.5×10⁻⁶/mm, less than or equal to 2.0×10⁻⁶/mm, less than or equal to 1.5×10⁻⁶/mm, less than or equal to 1.0×10⁻⁶/mm, or less than or equal to 0.5×10⁻⁶/mm. As described herein, the warp is measured as a function of the diagonal measurement of a glass article for which warp is to be determined. The diagonal is measured on a surface of the glass article having the greatest surface area. For example, if a glass article has an essentially rectangular shape (i.e., rectangular with rounded corners), the diagonal referred to in the warp measurement will be measured as a diagonal of the essentially rectangular surface. As another example, if the glass article has a circular surface, the diagonal is the diameter of the circle. As a further example, if the glass article has an oval-shaped surface, the diagonal is the longest straight line that can be drawn from one point on the circumference of the oval-shaped surface to another point on the oval-shaped surface. Thus, in embodiments, if a glass article is essentially rectangular and has a diagonal of 10 mm, the warp will be, in embodiments, less than 0.15/10²=0.0015 mm

In another embodiment, a method for compensating for warp in a glass article comprises placing a first surface of the glass article on a first surface of a fixture, wherein the glass article comprises the first surface, a second surface opposite to the first surface, and a plurality of edge surfaces at a periphery of the glass article that span between the first surface and the second surface, and the fixture comprises the first surface configured so that when the first surface of the glass article is placed on the first surface of the fixture, the first surface of the glass article is supported by the first surface of the fixture. The glass article is then heated to a first temperature in a viscoelastic range. The glass article is then cooled on the fixture to a second temperature such that a temperature gradient exists from the first surface of the glass article to the second surface of the glass article; and the glass article is removed from the fixture and cooled to room temperature.

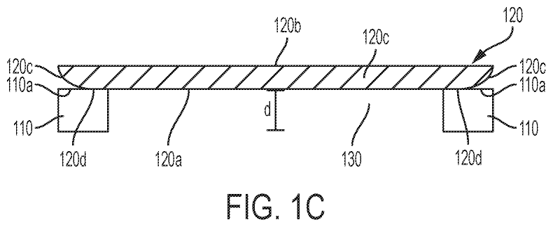

With reference now to FIG. 3, a glass article 120 is placed on a fixture 310. The glass article 120 comprises a first surface 120a, a second surface 120b, which is opposite to the first surface 120a, and a plurality of edge surfaces 120c at a periphery of the glass article 120 and spanning between the first surface 120a and the second surface 120b. As shown in the embodiment depicted in FIG. 3, the first surface 120a of the glass article 120 is placed on a first surface 310a of the fixture 310. The first surface 310a of the fixture 310 is configured so that when the first surface 120a of the glass article 120 is placed on the first surface 310a of the fixture 310, the first surface 120a of the glass article 120 is supported by the first surface 310a of the fixture 310. In some embodiments, the first surface 120a of the glass article 120 and the first surface 310a of the fixture 310 are manufactured such that a maximum surface area of the first surface 120a of the glass article 120 contacts the first surface 310a of the fixture 310—with the exception of inherent surface roughness or unintended variations in either the first surface 120a of the glass article 120 or the first surface 310a of the fixture 310.

As discussed above, the shape of the glass article 120 is not particularly limited. In some embodiments, the glass article may be substantially rectangular in shape. In some embodiments, one or more of the edge surfaces 120c of the glass article 120 may be beveled to form a 2.5D glass article 120. As an example, the glass article 120 in the embodiment depicted in FIG. 3 comprise beveled edge surfaces on the two short ends of the glass article 120. In some embodiments, the glass article 120 is placed on the first surface 310a of the fixture 310 so that the one or more beveled edge surfaces 120c of the glass article 120 face the first surface 310a of the fixture 310.

Once placed on the fixture 310, the glass article 120 is heated to a first temperature that is within the viscoelastic range. The glass composition of the glass article 120 is not limited, but it should be understood that different glass compositions will need to be heated to different temperatures to obtain the desired viscoelasticity. Therefore, in some embodiments, the glass article 120 is heated to a temperature where the viscosity of the glass is from greater than or equal to 10⁹ poise to less than or equal to 10¹⁴ poise, such as from greater than or equal to 10⁹ poise to less than or equal to 10¹³ poise, from greater than or equal to 10⁹ poise to less than or equal to 10¹² poise, from greater than or equal to 10⁹ poise to less than or equal to 10¹¹ poise, or from greater than or equal to 10⁹ poise to less than or equal to 10¹⁰ poise. In some embodiments, the glass article 120 is heated to a temperature where the viscosity of the glass is from greater than or equal to 10¹⁰ poise to less than or equal to 10¹⁴ poise, from greater than or equal to 10¹¹ poise to less than or equal to 10¹⁴ poise, from greater than or equal to 10¹² poise to less than or equal to 10¹⁴ poise, or from greater than or equal to 10¹³ poise to less than or equal to 10¹⁴ poise. In some embodiments, the glass article 120 is heated to a temperature where the viscosity of the glass is from greater than or equal to 10¹⁰ poise to less than or equal to 10¹³ poise.

Once the glass article 120 is heated to a temperature such that the glass article 120 has the desired viscosity, the glass article 120 may be cooled to a second temperature that is below the first temperature described above. This cooling allows the glass article 120 to become more viscous so that it can safely be removed from the fixture 310. As discussed above, different glass compositions will need to be cooled to different temperatures to obtain the desired viscosity. In some embodiments, the glass article 120 is cooled to a second temperature such that the glass article 120 has a viscosity that is greater than or equal to 10¹³ poise, such as greater than or equal to 10¹⁴ poise, greater than or equal to 10¹⁵ poise, greater than or equal to 10¹⁶ poise, or greater than or equal to 10¹⁷ poise.

The glass article 120 is cooled while it is still on the fixture 310 so that a temperature gradient is formed between the first surface 120a of the glass article 120 and the second surface 120b of the glass article 120. This temperature gradient between the first surface 120a of the glass article 120 and the second surface 120b of the glass article 120 causes the glass article 120 to have a thermal history that forms stresses in the glass article 120 that can compensate for the warp of the glass article 120 caused by subsequent chemical strengthening. The thermal history in the glass article 120 can be controlled by removing the glass article 120 from the fixture 310 at different second temperatures, or by changing the mold and/or furnace temperatures.

It should be understood that in embodiments, the glass article may be heated and cooled by any suitable method or mechanism. For example, in some embodiments, the fixture 310 and the glass article 120 may be placed in a furnace to heat the glass article 120, and after heating the glass article 120 may be allowed to cool without introducing any cooling gas into the furnace, or a gas may be introduced into the furnace to promote cooling of the glass article 120. In some embodiments, a door of the furnace may be opened to promote cooling of the glass article 120. In some embodiments, the glass article 120 may be heated by heating the fixture 310 and allowing conduction of the heat from the fixture 310 to the glass article 120.

Once the glass article 120 is cooled to the second temperature, the glass article 120 is removed from the fixture 310 and allowed to cool to room temperature. This can be done by removing the glass article 120 from the fixture 310 and allowing the glass article 120 to sit at ambient conditions for a period of time, or this can be done by removing the glass article 120 from the fixture 310 and actively cooling the glass article by any suitable method or mechanism.

As discussed above, embodiments disclosed herein may compensate for warp that occurs when the glass article 120 is chemically strengthened, such as, for example, by ion exchange strengthening. Ion exchange strengthening, in some embodiments, conducted by contacting the glass article 120—after it has been cooled to room temperature—with an ion exchange solution comprising a molten salt selected from the group consisting of molten potassium nitrate (KNO₃), molten sodium nitrate (NaNO₃), and mixtures thereof. The ion exchange solution may, in some embodiments, be maintained at a temperature from greater than or equal to 360° C., such as greater than or equal to 380° C., greater than or equal to 400° C., greater than or equal to 420° C., greater than or equal to 440° C., or greater than or equal to 450° C. In embodiments, the maximum temperature of the ion exchange solution is less than or equal to 550° C. It should be understood that any ion exchange strengthening process may be used to chemically strengthen the glass article 120, and the type of ion exchange process that is used—including the type of ion exchange solution used—will depend upon the composition of the glass article 120.

After the ion exchange strengthening process, the warp/diagonal of the glass article, according to some embodiments, is less than or equal to 6.0×10⁻⁶/mm, such as less than or equal to 5.5×10⁻⁶/mm, less than or equal to 4.5×10⁻⁶/mm, less than or equal to 4.0×10⁻⁶/mm, less than or equal to 3.5×10⁻⁶/mm, less than or equal to 3.0×10⁻⁶/mm, less than or equal to 2.5×10⁻⁶/mm, less than or equal to 2.0×10⁻⁶/mm, less than or equal to 1.5×10⁻⁶/mm, less than or equal to 1.0×10⁻⁶/mm, or less than or equal to 0.5×10⁻⁶/mm. The warp can be measured by any surface measurement method, such as light Interferometry, deflectometry, laser; such as by a deflectometer.

In another embodiment, a method for compensating for warp in a glass article comprises removing a portion from a surface of the glass article determined to provide compensation for warping caused by chemical strengthening; and ion exchanging the glass article by contacting the glass article with an ion exchange solution comprising a molten salt selected from molten potassium nitrate, molten sodium nitrite, and a mixture thereof at a temperature of greater than or equal to 360° C.

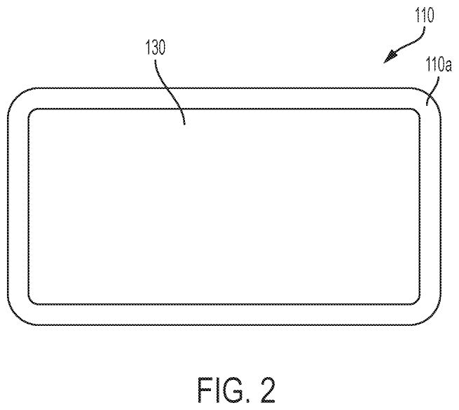

FIG. 4 is a top view of a substantially rectangular glass article 120. As discussed above, the shape of the glass article 120 is not particularly limited. In some embodiments, one or more of the edge surfaces 120c of the glass article 120 may be beveled to form a 2.5D glass article 120. Portions 410 of the first surface 120a of the glass article 120 may be removed to compensate for the warp of the glass article after ion exchange processing. These portions 410 may be determined by methods disclosed in U.S. Patent Application Publication No. 2016/0162615, which is incorporated herein by reference in its entirety. Once these portions 410 of the first surface 120a of the glass article 120 are determined, the portions 410 can be physically removed from the glass article 120.

Removing the portions 410 of the first surface 120a of the glass article 120 can be accomplished by any suitable method, such as etching, grinding, or machining. In some embodiments, the portions 410 are removed from the first surface 120a of the glass article 120 using computer numerical control (CNC) machining. In some embodiments, the depth of the portions 410 removed from the first surface 120a of the glass article 120 is from greater than or equal to 50 μm to less than or equal to 200 μm, such as from greater than or equal to 50 μm to less than or equal to 180 μm, from greater than or equal to 50 μm to less than or equal to 160 μm, from greater than or equal to 50 μm to less than or equal to 140 μm, from greater than or equal to 50 μm to less than or equal to 120 μm, from greater than or equal to 50 μm to less than or equal to 100 μm, from greater than or equal to 50 μm to less than or equal to 80 μm, or from greater than or equal to 50 μm to less than or equal to 60 μm. In some embodiments, the depth of the portions 410 removed from the first surface 120a of the glass article 120 is from greater than or equal to 70 μm to less than or equal to 200 μm, from greater than or equal to 90 μm to less than or equal to 200 μm, from greater than or equal to 110 μm to less than or equal to 200 μm, from greater than or equal to 130 μm to less than or equal to 200 μm, from greater than or equal to 150 μm to less than or equal to 200 μm, from greater than or equal to 170 μm to less than or equal to 200 μm, or from greater than or equal to 190 μm to less than or equal to 200 μm. In some embodiments, the depth of the portions 410 removed from the first surface 120a of the glass article 120 is from greater than or equal to 60 μm to less than or equal to 190 μm, from greater than or equal to 70 μm to less than or equal to 180 μm, from greater than or equal to 80 μm to less than or equal to 170 μm, from greater than or equal to 90 μm to less than or equal to 160 μm, from greater than or equal to 100 μm to less than or equal to 150 μm, from greater than or equal to 110 μm to less than or equal to 140 μm, or from greater than or equal to 120 μm to less than or equal to 130 μm.

As discussed above, embodiments disclosed herein may compensate for warp that occurs when the glass article 120 is chemically strengthened, such as, for example, by ion exchange strengthening. Ion exchange strengthening is, in some embodiments, conducted by contacting the glass article 120—after it has been cooled to room temperature—with an ion exchange solution comprising a molten salt selected from the group consisting of molten potassium nitrate (KNO₃), molten sodium nitrate (NaNO₃), and mixtures thereof. The ion exchange solution may, in some embodiments, be maintained at a temperature from greater than or equal to 360° C., such as greater than or equal to 380° C., greater than or equal to 400° C., greater than or equal to 420° C., greater than or equal to 440° C., or greater than or equal to 450° C. In embodiments, the maximum temperature of the ion exchange solution is less than or equal to 550° C. It should be understood that any ion exchange strengthening process may be used to chemically strengthen the glass article 120, and the type of ion exchange process that is used—including the type of ion exchange solution used—will depend upon the composition of the glass article 120.

After the ion exchange strengthening process, the warp/diagonal of the glass article, according to some embodiments, is less than or equal to 6.0×10⁻⁶/mm, such as less than or equal to 5.5×10⁻⁶/mm, less than or equal to 4.5×10⁻⁶/mm, less than or equal to 4.0×10⁻⁶/mm, less than or equal to 3.5×10⁻⁶/mm, less than or equal to 3.0×10⁻⁶/mm, less than or equal to 2.5×10⁻⁶/mm, less than or equal to 2.0×10⁻⁶/mm, less than or equal to 1.5×10⁻⁶/mm, less than or equal to 1.0×10⁻⁶/mm, or less than or equal to 0.5×10⁻⁶/mm.

### EXAMPLES

Embodiments will be further clarified by the following examples.

### Example 1

A fixture with concave recess having a depth of about 3 mm was used to allow sufficient clearance for 2.5D glass movement. The glass article having a composition as shown in Table 1 below and having a dimension of 150 mm×70 mm×0.8 mm, a bevel 2.5 mm wide 0.5 mm deep and a 0.1 mm chamfer on non-beveled side was placed on the fixture with the bevel facing the fixture surface, and both short ends of the glass article were in contact with the fixture thereby supporting and suspending the long ends of the glass article.

TABLE 1

| oxide (mol %) | 5318 |
|---|---|
| SiO₂ | 57.43 |
| Al₂O₃ | 16.10 |
| Na₂O | 17.05 |
| MgO | 2.81 |
| TiO₂ | 0.003 |
| P₂O₅ | 6.54 |

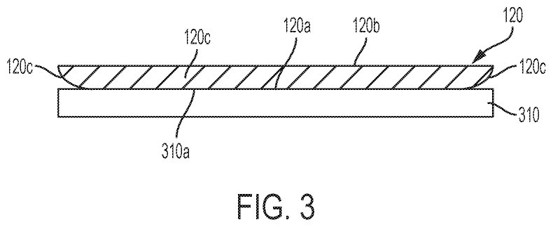

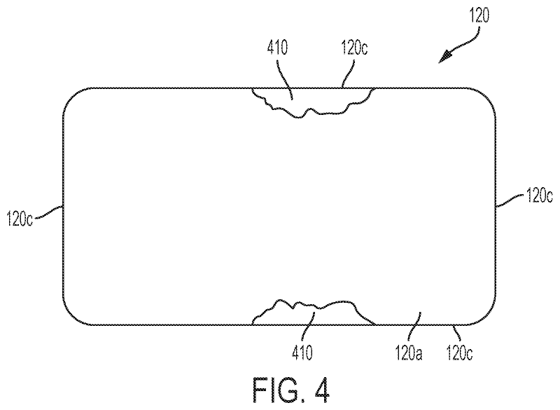

The thermal process was setup to raise the glass article temperature from room temperature to a temperature in the viscoelastic range, where the glass article will sag under its own weight. The minimum temperature where glass will sag under its own, for this experiment, was a maximum fixture temperature of about 662° C. (η=10^{13.1} poise) where η is resistance to deformation by shear stress or the ratio of shear stress to shear velocity. The fixture and glass article were cooled in a controlled manner to 642° C. (η=10^{13.7} poise). Then, the glass article was removed from the fixture and allowed to cool to room temperature. FIGS. 5 and 6 graphically depict the furnace temperature settings and thermal profile of the fixture, respectively. The temperature within the furnace is precisely controlled to +/−2° C. by placing the furnace modules in a power control state, and controlling the residence time in each module based on a trigger temperature for mold movement to next segment of process. The mold temperature and cycle time are tuned to achieve the target pre-ion exchange warp for compensating the ion exchange warp.

### Example 2

A flat plate fixture, such as the fixture shown in FIG. 3, was used with the objective of creating a thermal gradient in the glass article, which has the flat plate fixture on one side (below the glass article) and the furnace heating elements on the other (above the glass article). The glass article having dimensions as disclosed in Example 1 and a composition disclosed in Table 1 is placed with the 2.5D bevel facing the fixture surface, and is supported completely by the fixture when loaded onto the fixture at the start of the process.

The fixture and the glass article were heated in the same way as Example 1, bringing the glass article in the viscoelastic zone with a maximum fixture temperature of about 680° C. (η=10^{12.5} poise). The fixture and furnace are adjusted to setup a thermal gradient in the glass article. The thermal gradient is controlled by adjusting the furnace temperature so that the atmospheric temperature within the furnace differs from the temperature of the mold. The fixture and glass article were then cooled, with a controlled thermal gradient in the mold as it cooled to about 642° C. (η=10^{13.7} poise) before removing the glass article from the fixture and cooling the glass article to room temperature.

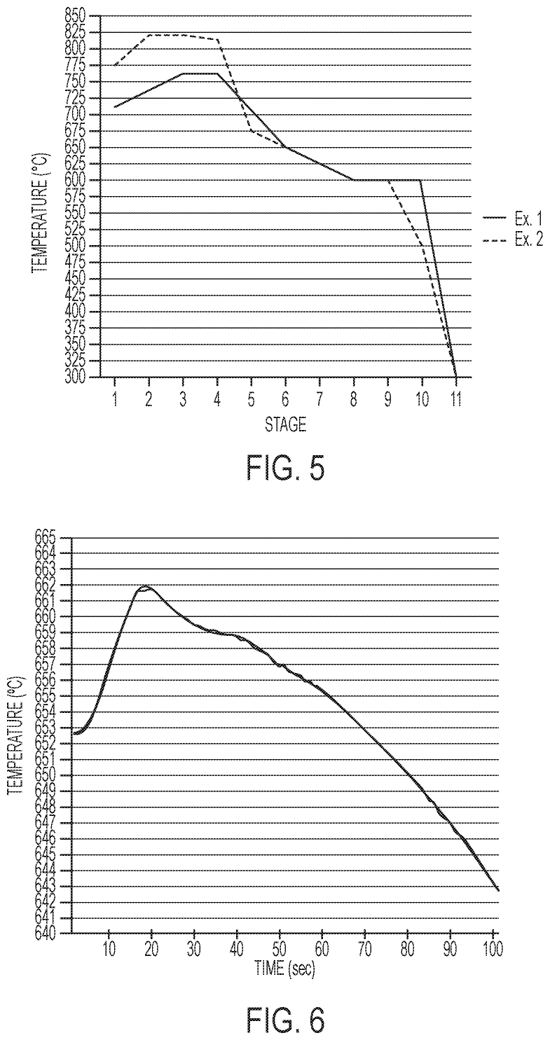

The process thermals were tuned to achieve a target pre-ion exchange warp for compensating the ion exchange warp. FIGS. 5 and 7 graphically depict the furnace temperature settings and thermal profile of the fixture, respectively.

### Example 3

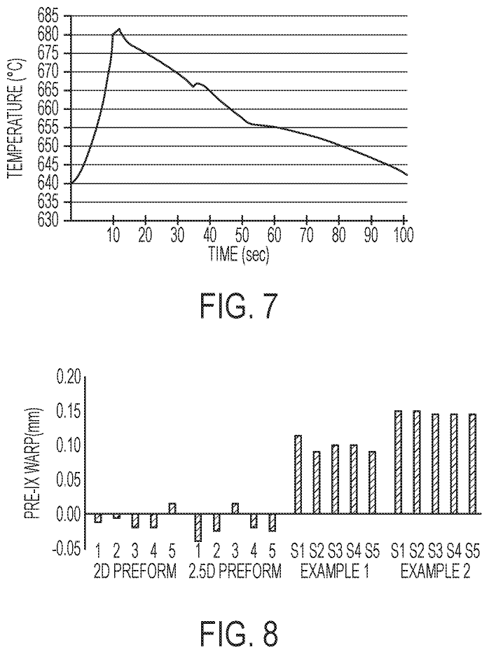

The process of Examples 1 and 2 were repeated with 4 additional glass samples (for a total of 5 samples for Example 1 and 5 samples for Example 2). The pre-ion exchange warp was measured and is graphically depicted in FIG. 8 and compared to (1) the pre-ion exchange warp of a 2D glass article (i.e., a glass article without a beveled edge surface), and (2) the pre-ion exchange warp of a non-compensated 2.5D glass article.

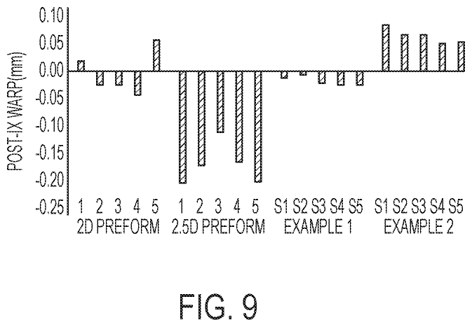

The glass article samples were then ion exchanged and the post-ion exchange warp was measured and is graphically depicted in FIG. 9 and compared to (1) the pre-ion exchange warp of a 2D glass article (i.e., a glass article without a beveled edge surface), and (2) the pre-ion exchange warp of a non-compensated 2.5D glass article.

As a comparison, an uncompensated 2.5D part has about −205 μm of warp along the long centerline after −160 μm of ion exchange process warp. Parts formed in Example 1 and Example 2 had lower post-ion exchange warp (−30 μm and +65 μm, respectively) due to the pre-ion exchange compensation warp imparted by each method. The pre-ion exchange warp can be further tuned to get post-ion exchange 2.5D parts with even less warp.

The thermal profiles for Examples 1 and 2 are given in FIG. 5 and FIG. 6, respectively.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for compensating for warp in a glass article comprising:
placing a first surface of the glass article on a first surface of a fixture, wherein
the glass article comprises the first surface, a second surface opposite and the first surface, and a plurality of edge surfaces at a periphery of the glass article that span between the first surface and the second surface, and
the fixture comprises the first surface having a recess configured so that when the first surface of the glass article is placed on the first surface of the fixture only a portion of the first surface of the glass article contacts the first surface of the fixture;
heating the glass article to a first temperature in a viscoelastic range such that the glass article sags into the recess in the first surface of the fixture; and
cooling the glass article on the fixture to a second temperature

2. The method according to claim 1, wherein the glass article is a 2.5D glass article and at least one of the plurality of edge surfaces is a beveled edge surface.

3. The method according to claim 2, wherein the beveled edge surface is configured such that when the first surface of the glass article is placed on the first surface of the fixture, the beveled edge surface is facing the first surface of the fixture.

4. The method according to claim 1, wherein the recess is a through-hole in the fixture.

5. The method according to claim 1, wherein the recess is a concave portion in the first surface of the fixture.

6. The method of claim 1, wherein the recess has an average depth of at least 2 mm.

7. The method of claim 1, wherein heating the glass article to the first temperature comprises heating the glass article to a temperature where a viscosity of the glass article is from greater than or equal to 10⁸ poise to less than or equal to 10¹² poise.

8. The method of claim 1, wherein heating the glass article to the first temperature comprises heating the glass article to a temperature where a viscosity of the glass article is from greater than or equal to 10⁹ poise to less than or equal to 10¹¹ poise.

9. The method of claim 7, wherein cooling the glass article to the second temperature comprises cooling the glass article to temperature where a viscosity of the glass article is greater than or equal to 10¹¹ poise.

10. The method of claim 1, wherein the method further comprises, after cooling the glass article to room temperature, ion exchanging the glass article by contacting the glass article with an ion exchange solution comprising a molten salt selected from molten potassium nitrate, molten sodium nitrite, and a mixture thereof at a temperature of greater than or equal to 360° C.

11. The method of claim 10, wherein the warp/diagonal² of the glass article after the glass article has been ion exchanged is less than or equal to 6.0×10⁻⁶/mm.

12. A method for compensating for warp in a glass article comprising:
placing a first surface of the glass article on a first surface of a fixture, wherein
the glass article comprises the first surface, a second surface opposite and the first surface, and a plurality of edge surfaces at a periphery of the glass article that span between the first surface and the second surface, and
the fixture comprises the first surface configured so that when the first surface of the glass article is placed on the first surface of the fixture, the first surface of the glass article is supported by the first surface of the fixture;
heating the glass article to a first temperature in a viscoelastic range;
cooling the glass article on the fixture to a second temperature such that a temperature gradient exists from the first surface of the glass article to the second surface of the glass article; and

13. The method according to claim 12, wherein the glass article is a 2.5D glass article and at least one of the plurality of edge surfaces is a beveled edge surface.

14. The method according to claim 13, wherein the beveled edge surface is configured such that when the first surface of the glass article is placed on the first surface of the fixture, the beveled edge surface is facing the first surface of the fixture.

15. The method according to claim 12, wherein heating the glass article to the first temperature comprises heating the glass article to a temperature where a viscosity of the glass article is from greater than or equal to 10⁹ poise to less than or equal to 10¹⁴ poise.

16. The method according to claim 12, wherein heating the glass article to the first temperature comprises heating the glass article to a temperature where a viscosity of the glass article is from greater than or equal to 10¹⁰ poise to less than or equal to 10¹³ poise.

17. The method of claim 15, wherein cooling the glass article on the fixture to a second temperature comprises cooling the glass article to temperature where a viscosity of the glass article is greater than or equal to 10¹⁴ poise.

18. The method of claim 12, wherein the method further comprises, after cooling the glass article to room temperature, ion exchanging the glass article by contacting the glass article with an ion exchange solution comprising a molten salt selected from molten potassium nitrate, molten sodium nitrite, and a mixture thereof at a temperature of greater than or equal to 360° C.

19. The method of claim 18, wherein the warp/diagonal² of the glass article after the glass article has been ion exchanged is less than or equal to 6.0×10⁻⁶/mm.

20. A method for compensating for warp in a glass article comprising:
removing a portion from a surface of the glass article determined to provide compensation for warping caused by chemical strengthening; and
ion exchanging the glass article by contacting the glass article with an ion exchange solution comprising a molten salt selected from molten potassium nitrate, molten sodium nitrite, and a mixture thereof at a temperature of greater than or equal to 360° C.

21. The method of claim 20, wherein the removing is done by CNC machining.

22. The method of claim 20, wherein a thickness of the portion removed from the surface of the glass article is from greater than or equal to 50 μm to less than or equal to 200 μm.

23. The method of claim 20, wherein the warp/diagonal of the glass article after the glass article has been ion exchanged is less than or equal to 6.0×10⁻⁶/mm.
